(19) United States
(12) Patent Application Publication
(10) Pub. No.: US 2026/0101297 A1
(43) Pub. Date: Apr. 9, 2026

(54) UE INITIATED ON-DEMAND SSB WITH ZONE BASED NES CELL AVAILABILITY INFORMATION

(71) Applicant: QUALCOMM Incorporated, San Diego, CA (US)

(72) Inventors: Aria HASANZADEZONUZY, Jersey City, NJ (US); Yan ZHOU, San Diego, CA (US); Navid ABEDINI, Basking Ridge, NJ (US); Jianghong LUO, Skillman, NJ (US)

(21) Appl. No.: 18/906,126

(22) Filed: Oct. 3, 2024

(51) Int. Cl. H04W 56/00; H04B 17/318; H04W 52/02; H04W 52/36; H04W 74/0833; H04W 76/20

(52) U.S. Cl. CPC H04W 56/0015; H04B 17/328; H04W 52/0235; H04W 52/367; H04W 74/0833; H04W 76/20

(57) ABSTRACT

A method for wireless communication at a user equipment (UE) and related apparatus are provided. In the method, the UE transmits a first request for turning on on-demand synchronization signal block (OD-SSB) of a candidate network energy saving (NES) cell. The first request includes location information of the UE that is in a radio resource control (RRC) idle or inactive state. The UE further communicates with the candidate NES cell or an anchor cell for the candidate NES cell based on an availability of the candidate NES cell.

### TECHNICAL FIELD

The present disclosure relates generally to communication systems and, more particularly, to UE initiated on-demand synchronization signal block (SSB) in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to transmit a first request for turning on on-demand synchronization signal block (OD-SSB) of a candidate network energy saving (NES) cell, where the first request includes location information of the UE that is in a radio resource control (RRC) idle or inactive state; and communicate with the candidate NES cell or an anchor cell for the candidate NES cell based on the availability of the candidate NES cell.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to receive, from a UE in an RRC idle or inactive state, a first request for turning on the OD-SSB of a candidate NES cell, where the first request includes location information of the UE; and communicate with the UE based on the availability of the candidate NES cell.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE requesting on-demand synchronization signal block (OD-SSB) with UE location information in accordance with various aspects of the present disclosure.

FIG. 5 is a diagram illustrating an example of zone-based network energy saving (NES) cell availability information in accordance with various aspects of the present disclosure.

FIG. 6 is a call flow diagram illustrating a method of wireless communication in accordance with various aspects of the present disclosure.

FIG. 7 is a flowchart illustrating methods of wireless communication at a UE in accordance with various aspects of the present disclosure.

FIG. 8 is a flowchart illustrating methods of wireless communication at a UE in accordance with various aspects of the present disclosure.

FIG. 9 is a flowchart illustrating methods of wireless communication at a network entity in accordance with various aspects of the present disclosure.

FIG. 10 is a flowchart illustrating methods of wireless communication at a network entity in accordance with various aspects of the present disclosure.

FIG. 11 is a diagram illustrating an example of a hardware implementation for an example apparatus and/or UE.

FIG. 12 is a diagram illustrating an example of a hardware implementation for an example network entity.

### DETAILED DESCRIPTION

In wireless communication, a user equipment (UE) in a radio resource control (RRC) idle or inactive state may locate a suitable, campable network energy saving (NES) cell for connection. A campable NES cell may correspond to a cell on which the UE is able to camp. An NES cell is a cell that employs energy saving technologies and strategies to minimize power consumption. For example, an NES cell may employ network savings during periods of low traffic or in areas with low user density. Such a cell may have times when it does not transmit a synchronization signal block (SSB), a signal that facilitates initial UE-network communication. For example, the NES cell may not transmit an SSB unless there is a UE camped or connected to the NES cell. Hence, a UE may need to request the activation or deactivation (ON/OFF) of an on-demand SSB (OD-SSB) from nearby NES cells in order to receive an SSB for measurements. However, the unavailability of the location of the NES cells, which are potentially sensitive information that may not be disclosed by the network, may complicate the process of the UE requesting OD-SSB. For example, if the UE is not aware of the location of the NES cell, the UE does not know to request the OD-SSB from the NES cell. Example aspects presented herein provide methods and apparatus that enable UEs to request OD-SSB without the exact locations of nearby NES cells. The aspects enable the UE to obtain the OD-SSB while allowing for the protection of location information about the NES cells.

Various aspects relate generally to wireless communication. Some aspects more specifically relate to UE-initiated OD-SSB with zone-based NES cell availability information. In some examples, the UE may transmit a first request for turning on the OD-SSB of a candidate NES cell. The first request may include location information of the UE that is in the RRC idle or inactive state. The UE may further communicate with the candidate NES cell or an anchor cell for the candidate NES cell based on the availability of the candidate NES cell. In some examples, the UE may receive cell availability information from the anchor cell. The cell availability information may include the presence or absence of a candidate NES cell in each zone of one or more zones, and each zone of the one or more zones may correspond to the geographic region, the beam coverage area of one or more beams, the reference signal received power (RSRP) range of a reference signal, or the intersection of multiple RSRP ranges respectively corresponding to multiple cells. In some examples, the UE may transmit the first request when the candidate NES cell is present in at least one zone of the one or more zones.

Particular aspects of the subject matter described in this disclosure can be implemented to realize one or more of the following potential advantages. In some examples, by introducing UE-initiated, OD-SSB activation mechanisms based on zone-based NES cell availability information, the described techniques provide more dynamic and efficient use of network energy and better service availability without compromising user privacy or network security. In some aspects, by enabling UEs to send requests for SSB activation when certain thresholds are met, the described techniques reduce unnecessary transmissions and overall signaling overhead, thereby improving the efficiency of wireless communication. In some aspects, by allowing for the UE to send the OD-SSB requests directly to NES cells based on transmission parameters adjusted for individual zones, the described techniques reduce the UE's dependency on anchor cells and expedite the SSB activation process, thereby enhancing the responsiveness of the network and minimizing delays in signal availability.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

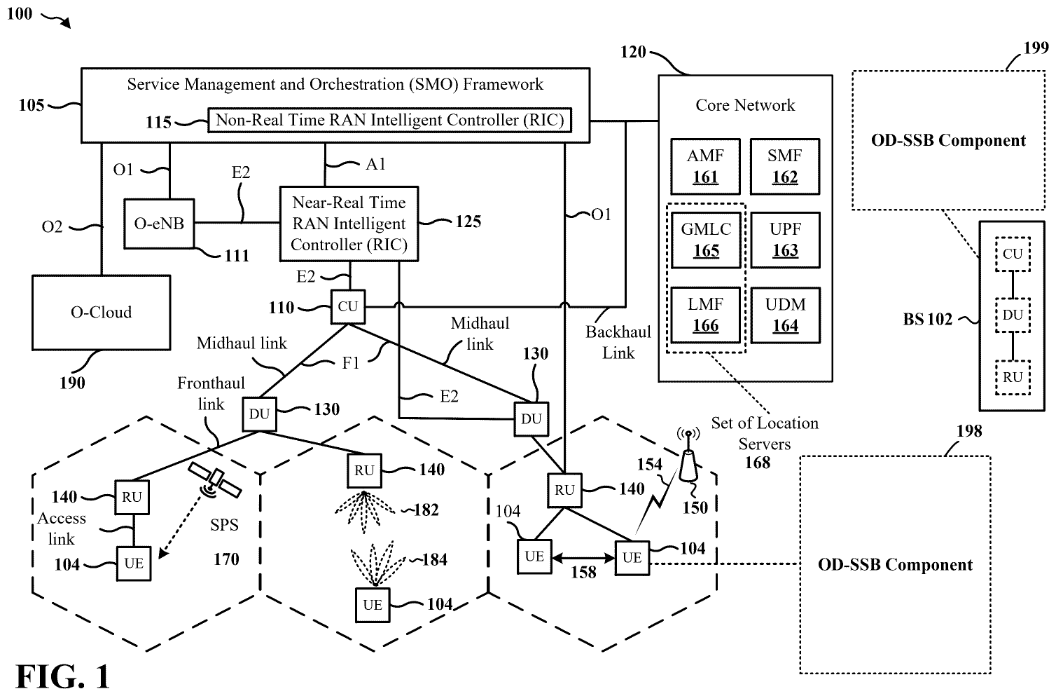

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an OD-SSB component 198. The OD-SSB component 198 may be configured to transmit a first request for turning on the OD-SSB of a candidate NES cell, where the first request includes location information of the UE that is in an RRC idle or inactive state; and communicate with the candidate NES cell or an anchor cell for the candidate NES cell based on the availability of the candidate NES cell. In certain aspects, the base station 102 may include an OD-SSB component 199. The OD-SSB component 199 may be configured to receive, from a UE in an RRC idle or inactive state, a first request for turning on the OD-SSB of a candidate NES cell, where the first request includes location information of the UE; and communicate with the UE based on the availability of the candidate NES cell. Although the following description may be focused on 5G NR, the concepts described herein may be applicable to other similar areas, such as LTE, LTE-A, CDMA, GSM, and other wireless technologies.

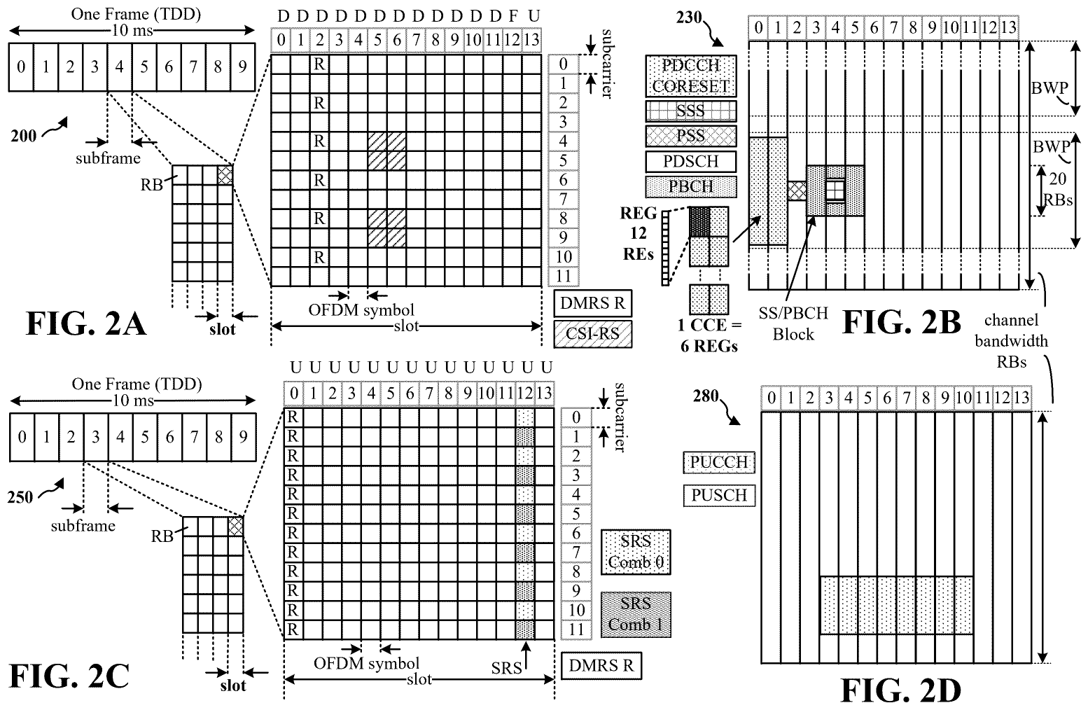

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

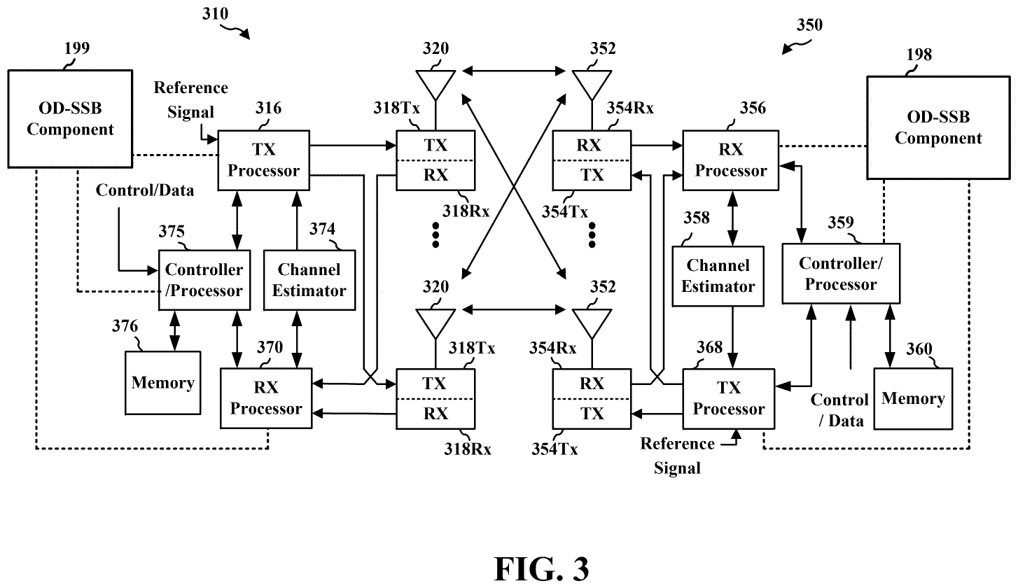

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the OD-SSB component 198 of FIG. 1.

At least one of the TX processor 316, the RX processor 370, and the controller/processor 375 may be configured to perform aspects in connection with the OD-SSB component 199 of FIG. 1.

In wireless communication, a UE in RRC idle or inactive state may locate a suitable campable NES cell for connection. An NES cell is a cell that employs energy saving technologies and strategies to minimize power consumption, for example, during periods of low traffic or in areas with low user density. Such a cell may not transmit an SSB, a signal that facilitates initial UE-network communication, unless it already has a UE camped or connected. Hence, the UE may need to request the activation or deactivation (ON/OFF) of an OD-SSB from nearby NES cells for measurements. However, the unavailability of the location of the NES cells, which are potentially sensitive information that may not be disclosed by the network, may complicate the process of requesting OD-SSB.

The present disclosure provides methods and apparatus that enable the UE to request turning on the OD-SSB of a NES cell without the exact locations of nearby NES cells. In some examples, the UE may request turning on the OD-SSB of a NES cell through an anchor cell (e.g., a cell connected with the NES cells), which is based on shared information between the UE and the anchor cell. For example, the shared information may include the UE's location, RSRP, and NES cell availability within specific zones. This information may be included in the on-demand request signaling. In some examples, the anchor cell may advise the UE on whether to send the request based on specific conditions. In some examples, the UE may request turning on the OD-SSB of a NES cell using an uplink wakeup signal, with the anchor cell providing assistance information to support the UE in transmitting the uplink wakeup signal.

In wireless communication, an OD-SSB for secondary cells (SCells) may be used to facilitate the transmission of SSB from a SCell (e.g., an activated or deactivated SCell) for layer 3 (L1) or layer 1 (L1) measurements to save network energy. In some examples, the network may indicate the ON/OFF commands (e.g., activated or deactivated commands) for OD-SSB from SCells to the connected UE. In some examples, a cell that supports OD-SSB SCell operations may support radio resource control (RRC) based or medium access control (MAC)-control element (MAC-CE) based signaling to indicate OD-SSB transmission on the cell.

In some examples, a UE may be in the RRC idle or inactive state. For such UEs to discover the most suitable campable NES cells (e.g., cells that may not transmit a synchronization signal block (SSB) unless there is a UE camped or connected to them), the UEs may request the activation or deactivation (e.g., turning ON or OFF) of the OD-SSB of nearby NES cells for measurements.

In some examples, the UE may request the activation of the OD-SSB from a NES cell when the distance between the UE and the NES cell falls below a threshold. However, this distance-based process relies on the UE's knowledge of the NES cell's location, which may be considered sensitive information that the network may not disclose. Example aspects presented herein provide methods and apparatus that enable UEs to request OD-SSB without the exact locations of nearby NES cells.

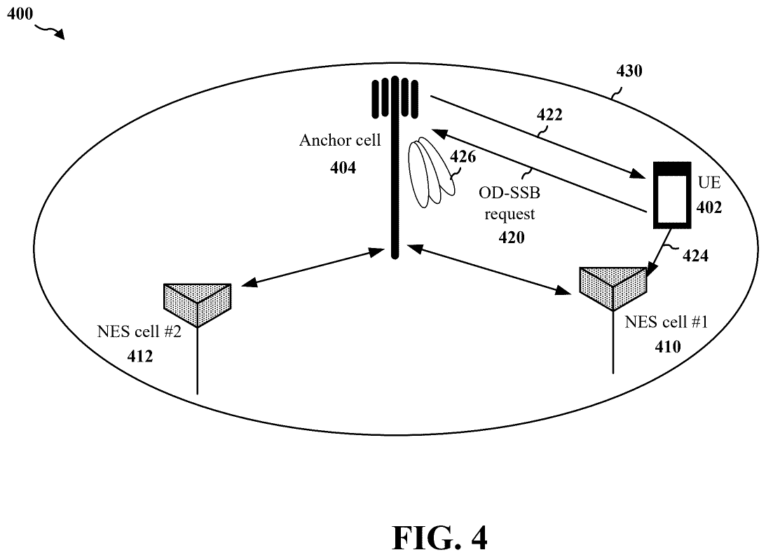

In some aspects, the UE may transmit an OD-SSB request via an anchor cell with the location information of the UE. For example, the UE may transmit an OD-SSB request with its own location and the measured signal quality, such as the measured reference signal received power (RSRP) of an anchor cell. FIG. 4 is a diagram 400 illustrating an example of a UE requesting OD-SSB with UE location information in accordance with various aspects of the present disclosure. As shown in FIG. 4, in some examples, to discover nearby NES cells (e.g., NES cell #1 410, NES cell #2 412), the UE 402, which may be in the RRC idle or inactive state, may send an OD-SSB request 420 to an anchor cell 404 to activate (e.g., turn on) the OD-SSB for any NES cells (e.g., NES cell #1 410, NES cell #2 412) within range 430.

In some examples, the OD-SSB request 420 may contain at least the location information of UE 402 and may be transmitted using messages such as Msg3 or MsgA. The anchor cell 404, upon receiving the request 420, may provide necessary information about the NES cell to the UE, including details like the cell ID, synchronization raster frequency (e.g., a set of frequencies used for the transmission of synchronization signals, such as SSB), SSB configuration, and system information through subsequent messages such as Msg4, MsgB, or later communications. Based on the location information of UE 402, the network may activate (e.g., turn on) SSBs of NES cells that are close to the UE 402 (e.g., NES cell #1 410) without disclosing the locations of these NES cells to the UE 402.

In some aspects, the anchor cell (e.g., anchor cell 404) may indicate (e.g., at 422) UE 402 to request for the activation (e.g., turning on) of the SSBs of NES cells if the RSRP or received signal strength quality (RSRQ) of the anchor cell 404 (e.g., based on SSB or any other reference signal) falls below a certain threshold. In some examples, this threshold may be indicated through system information block (SIB) or random access response (RAR). In some examples, the threshold may be specific to SSBs, allowing different thresholds for different SSBs for the observable NES cells. In some examples, when the RSRP (or RSRQ) of the anchor cell 404 is below this set threshold, the UE 402 may request the activation (e.g., turning on) of SSBs for NES cells, ensuring that the request is sent when the discovery of NES cells is feasible.

In some aspects, besides the UE's location, the UE's request (e.g., OD-SSB request 420) may include other information to facilitate the activation (e.g., turning on) of SSB on the NES cells. This information may include, for example, a radius or a minimum RSRP (or minimum RSRQ). For examples, based on this information, the network may activate (e.g., turn on) NES cells within the radius from the UE's location, or those NES cells whose RSRP (or RSRQ) exceeds the minimum RSRP (or RSRQ) in the UE's request. In some examples, the UE's request may further include information such as the maximum transmit power of the UE or the power state of the UE.

In some aspects, there may be no NES cell in the immediate vicinity of UE or accessible by the UE. In such cases, the anchor cell (e.g., anchor cell 404) may indicate the UE through Msg4 or subsequent messages that no NES cells are available. Additionally, the anchor cell may indicate the UE to send a new request for SSB activation if the UE moves to a new location that is more than a specified distance (e.g., X meters) away from its current position. For example, the distance (e.g., X) may be determined based on the distance between the UE to the nearest NES cell (e.g., the distance between UE 402 and NES cell #1 410). Additionally, this distance can be direction-specific. For example, the anchor cell may indicate the UE to move a certain distance (e.g., 10 meters) in a specific direction (e.g., north) before sending a new request. This mechanism may prevent the network from being overwhelmed by frequent and unnecessary requests from UEs to turn on SSBs of NES cells, thereby enhancing network efficiency and resource management.

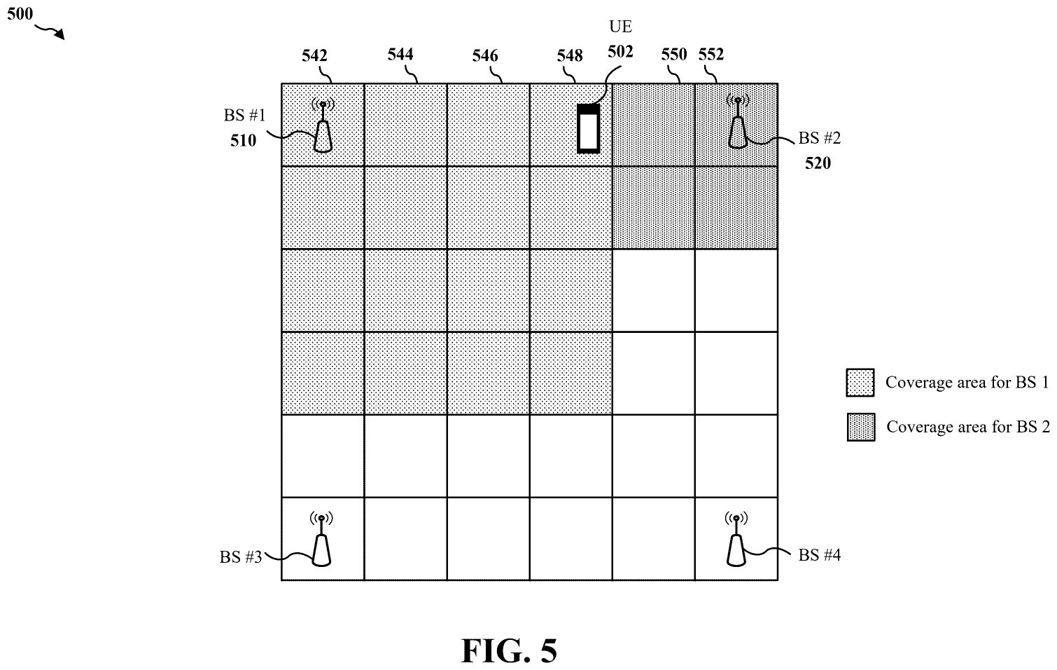

In some aspects, the UE may request for OD-SSB via an anchor cell based on NES cell availability information segmented by geographic zones. As used herein, an NES cell is “available” to a UE means the UE can communicate with the NES cell (e.g., the UE is in the coverage area of the NES cell). FIG. 5 is a diagram 500 illustrating an example of zone-based NES cell availability information in accordance with various aspects of the present disclosure. As shown in FIG. 5, in some aspects, the network may provide detailed NES cell availability information per geographic zone to the UE, and the UE may then send requests for SSB activation if an NES cell is detectable within the UE's current zone. For example, the coverage area of a base station (e.g., BS #1 510), which may serve as the anchor cell, may be divided into multiple square zones, such as zones 542, 544, 546, 548. Each of these zones may have a size of, for example, 10×10 m² or smaller. In some examples, zoning may be based on signal coverage patterns rather than geographic boundaries. For example, a zone may be defined as the whole or part of the coverage of one or multiple beams. For example, one zone may be defined as the coverage area of one SSB (e.g., SSB 1) with an RSRP range between −70 and −100 dBm. For example, another zone may be defined as the intersection of the coverage areas of two SSBs (e.g., SSB 1 and SSB 2).

In some examples, the definition of each zone may be based on the RSRP range. For example, one zone (e.g., a zone with zone ID Y₁) may correspond to the area where the RSRP is less than a first threshold (e.g., X₁), and another zone (e.g., a zone with zone ID Y₂) may correspond to the area where the RSRP less than a second threshold (e.g., X₂). In some examples, the definition of each zone may incorporate multiple anchor cells, allowing for a flexible zone setting based on varying signal strengths from different anchor cells. For example, one zone (e.g., a zone with zone ID Y₃) may correspond to the area where the RSRP of the first anchor cell (e.g., anchor cell 1) is less than a first value (e.g., X₁₁) and the RSRP of the second anchor cell (e.g., anchor cell 2) is less than a second value (e.g., X₁₂).

In some examples, the process for managing NES cell availability information and UE requests may be implemented in two steps. In the first step, the network may leverage previous connections to provide the UE with NES cell availability information for specific zones. This allows the UE to be informed about detectable NES cell IDs within its current zone or across one or more zones under the coverage of the anchor cell. For example, in FIG. 5, if the UE 502 is located in zone 548, the anchor cell may inform UE 502 about the availability of BS #1 510 in the UE's current zone 548 or the availability of BS #2 520 in the neighboring zones 550, 552.

In some examples, the NES cell availability information may be generated from previous UE reports and may be communicated to the UE in advance by a radio access network (RAN) node or server (e.g., via previous connections). In some examples, in addition to the detectable NES cell IDs in the zones, the network may also provide additional details for each NES cell, such as synchronization raster frequency, OD-SSB configurations, and system information.

In the second step, based on the NES cell availability information to each zone, the UE in the idle or inactive state may send a request to the anchor cell for activating (e.g., turning on) SSBs of accessible NES cells if there are accessible NES cells in the current zone. The request may include the zone ID or the NES cell IDs. Upon receiving the request, the network may activate (e.g., turn on) the corresponding NES cells. For example, if the UE 502 is provided with the NES cell availability information indicating the availability BS #1 510 in the UE's current zone 548, the UE may send a request to the anchor cell for activating (e.g., turning on) SSBs of BS #1 510. The request may include the zone ID for zone 548 and the NES cell ID for BS1 510. In some examples, if the UE detects no NES cells, the UE may send a new request if the UE moves more than a certain distance (e.g., X) in the same zone or moves to a new zone.

In some aspects, the network may use a mapping between zone IDs to NES cell IDs to indicate the NES cell availability information to the UE. For example, in FIG. 5, the NES cell ID of BS #1 510 may map to zones 542, 544, 546, 548, indicating that BS #1 510 is available in these zones. In some examples, the network may indicate the mapping to the UE, allowing the UE to include NES cell IDs in the request to activate (e.g., turn on) SSB to the anchor cell, rather than just zone IDs. In some examples, the UE may use their historical data to facilitate the transmission of the request. For example, if a UE has previously connected to an NES cell, it may save the NES cell ID and its own location data. This stored information can then be used to expedite future requests and interactions with the network.

In some aspects, the UE may transmit a request to activate OD-SSB directly to a NES cell (instead of an anchor cell) based on the NES cell availability information for the zones. For example, if transmission parameters for uplink wakeup signals (UL WUS) for a NES cell in the UE's current zone (e.g., zone 548 for UE 502), such as timing advance (TA), beam direction, and RACH occasions (RO) for the uplink wakeup signals, have been provided to the UE, the UE may transmit the request to activate OD-SSB to the NES cell (e.g., BS #1 510) based on these transmission parameters. In some examples, these transmission parameters may be determined by the network from previous measurements taken from UEs within the same zone. For example, in FIG. 4, assuming NES cell #1 410 is available at the UE 402's current zone (e.g., UE 402 is in the coverage area of NES cell #1 410), if transmission parameters for UL WUS for NES cell #1 410 have been provided to the UE 402, the UE 402 may transmit the request to activate OD-SSB to the NES cell #1 410 (e.g., via 424) based on these transmission parameters.

In some aspects, a UE may transmit a request to activate OD-SSB directly to NES cells based on zone-specific NES cell availability information. For example, the network may provide the appropriate transmission parameters for uplink wakeup signals for each detectable NES cell in each zone. The transmission parameters may include the timing advance (TA), the UE's transmit beam direction, and the network's RO or beam configuration for receiving the UL WUS. For example, the network may provide the appropriate transmission parameters for uplink wakeup signals for BS #1 510 for zones 542, 544, 546, 548.

In some examples, the network may indicate the TA for UL WUS for each detectable NES cell in each zone based on the downlink or uplink timing of a reference cell. For example, the network may indicate the TA for a NES cell (e.g., BS #1 510) in a first zone (e.g., zone 546) as an offset relative to the downlink timing or TA for the anchor cell measured by the UE 502 in the current zone (e.g., zone 548). If the first zone is small (e.g., a 5m×5m zone), these parameters may remain consistent in the zone. In larger zones, the network may indicate the TA for an NES cell (e.g., BS #1 510) as an offset relative to a specific value or range of the downlink timing or TA for the anchor cell.

In some aspects, the network may provide the uplink wake-up signal (UL WUS) transmission timing for each NES cell in terms of absolute time, such as coordinated universal time (UTC) or global positioning system (GPS) time. In some examples, the timing information allows the UE to bypass measuring the downlink timing of any reference cell or anchor cell, thereby enabling the UE to transmit the OD-SSB request directly to an NES cell even when the UE is outside the coverage area of any reference cell or anchor cell.

In some examples, the absolute transmission timing may be tailored specifically for each zone, considering factors such as the propagation delay between the NES cell and the center of the zone.

In some examples, when operating under a certain frequency band, such as FR2, the network may indicate the direction of the UE's transmit beam for the UL WUS and the corresponding receive occasion or receive beam at the network for each detectable NES cell within a zone.

In some aspects, in a scenario where detectable NES cells are actively monitoring for uplink wake signals (UL WUS), the UE may directly send a UL WUS to an NES cell to activate the NES cell. In some examples, the network may assign a cell as a “reference cell” that transmits the downlink timing reference signal. For example, referring to FIG. 4, the anchor cell 404 may be assigned as the reference cell. The anchor cell 404 may transmit downlink timing reference signal 426, which facilitate the UE 402 to directly send a UL WUS to an NES cell (e.g., NES cell #1 410). In some examples, the reference cell may be zone-specific, meaning different zones may have different reference cells.

In some examples, the network may provide the UL WUS TA of each NES cell based on the downlink timing reference signal from the reference cell. For example, assuming anchor cell 404 is the reference cell, the network may provide the UL WUS TA of each NES cell (e.g., NES cell #1 410, NES cell #2 412) based on the downlink timing reference signal 426 from the anchor cell 404.

In some examples, the network may indicate the direction of the UE's transmit beam for the UL WUS and the corresponding random access channel occasion (RO) for each NES cell within a zone. This indication may be based on the uplink measurements previously taken from other UEs within that zone for that NES cell.

In some aspects, the network might activate more NES cells than necessary, and some of the activated NES cells may be deactivated (e.g., turn off). That is, the OD-SSB from these NES cells may be deactivated (e.g., turned off).

In some aspects, if the network has activated (e.g., turned on) SSBs of NES cells more than necessary, the UE may communicate with the anchor cell to indicate which NES cells are not necessary and may be turned off. Based on the indication from the UE, the network may deactivate (e.g., turned off) the corresponding NES cell.

In some examples, the network may indicate UEs with a timer indicating the duration for which an NES cell will transmit an SSB. For example, this timer may be specific to each NES cell (meaning different NES cells may have different timers), specific zones (meaning different zones may have different timers), or defined specifications. In some examples, the indication of the timer may be communicated to the UE through the anchor cell (e.g., anchor cell 404). In some examples, the indication of the timer may be communicated to the UE through the NES cell (e.g., NES cell #1 410, NES cell #2 412). In some examples, the network may deactivate an NES cell if the time duration this NES cell has been transmitting OD-SSB has exceeded the time duration of the applicable timer, and the UE does not need to send any deactivation requests to the network.

In some examples, the UE may send an uplink signal to the network to indicate that it has moved out of the coverage area of an NES cell. Based on the UE's indication, the network may deactivate the NES cell that no longer provides coverage to the UE. In some examples, the network may monitor all idle or inactive UEs within the NES cell's coverage and use this uplink signal to determine whether to deactivate the NES cell. For example, if all previously tracked UEs have moved out of the coverage of an NES cell, the network may deactivate this NES cell. In some examples, the network may track the location or zone of every idle UE through, for example, network sensing or sounding reference signal (SRS) transmission from inactive UEs. Once it is determined that all UEs have moved out of the coverage area of an NES cell, the OD-SSB of the NES cell may be deactivated (e.g., turned off), conserving resources and optimizing network operations.

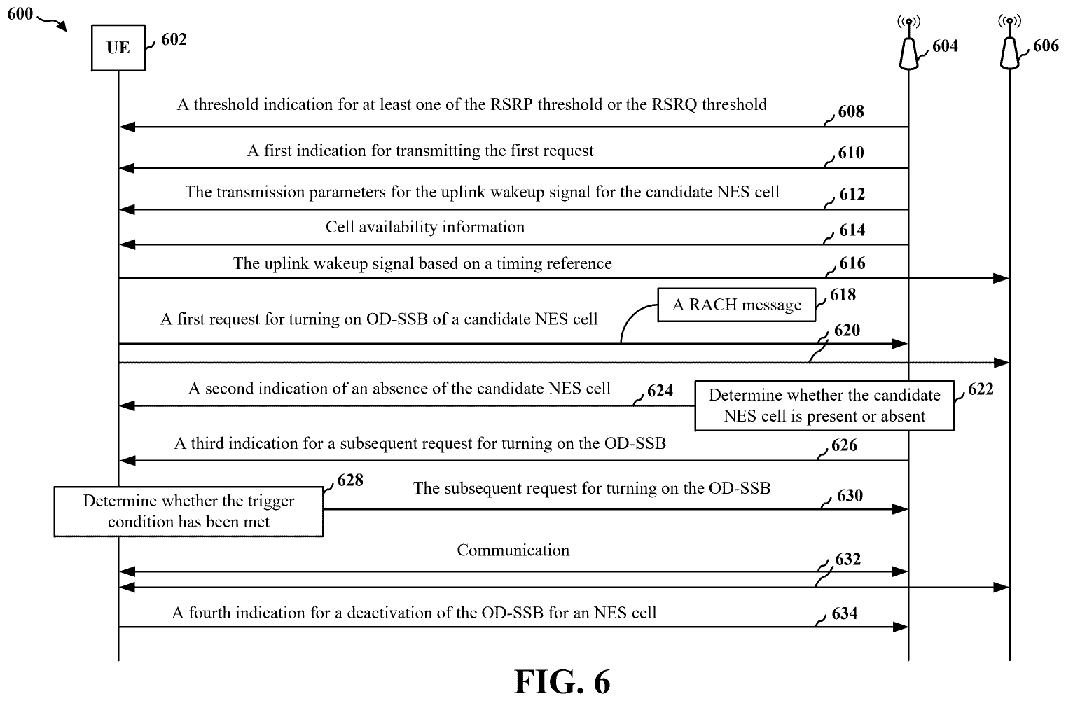

FIG. 6 is a call flow diagram 600 illustrating a method of wireless communication in accordance with various aspects of this present disclosure. Various aspects are described in connection with a UE 602, an anchor cell 604, and a candidate NES cell 606. The UE 602 may be UE 402, 502. The anchor cell 604 may be anchor cell 404.

The candidate NES cell 606 may be NES cell #1 410 or NES cell #2 412. Various aspects of the call flow diagram 600 may be performed by the UE 602, the anchor cell 604, or the candidate NES cell 606. Each of the anchor cell 604 and the candidate NES cell 606 may be a base station and/or one or more components of a base station (e.g., a CU 110, a DU 130, and/or an RU 140).

As shown in FIG. 6, at 608, the UE 602 may receive a threshold indication for at least one of the RSRP threshold or the RSRQ threshold for a signal received at the anchor cell 604. In some examples, the UE 602 may receive the threshold indicator in a system information block (SIB) or a random access response (RAR).

At 610, the UE 602 may receive from the anchor cell 604 a first indication for transmitting a first request for turning on the OD-SSB of a candidate NES cell (e.g., candidate NES cell 606). In some examples, the anchor cell 604 may send the first indication to the UE 602 when the RSRP of a signal received at the anchor cell 604 is smaller than the RSRP threshold. In some examples, the anchor cell 604 may send the first indication to the UE 602 when the RSRQ of a signal received at the anchor cell 604 is smaller than the RSRQ threshold. For example, referring to FIG. 4, the UE 402 may receive from the anchor cell 404 a first indication for transmitting a request for turning on the OD-SSB of a candidate NES cell at 422.

In some aspects, at 612, the UE 602 may receive, from the anchor cell 604, the transmission parameters for the uplink wakeup signal for the candidate NES cell 606. The transmission parameters may be the parameters that enable the UE 602 to transmit an uplink wakeup signal to the candidate NES cell 606. For example, the transmission parameters for the uplink wakeup signal may include the TA for the uplink wakeup signal, the UE's transmit beam direction for the uplink wakeup signal, a random access channel (RACH) occasion (RO) or beam for receiving the uplink wakeup signal. For example, the TA for the uplink wakeup signal may be based on downlink or uplink timing of a reference cell, a coordinated universal time (UTC) time, or a global positioning system (GPS) time. For example, referring to FIG. 4, the UE 402 may receive from the anchor cell 404 the transmission parameters for the uplink wakeup signal for the candidate NES cell. The transmission parameters may be the parameters that enable the UE 402 to transmit an uplink wakeup signal to the candidate NES cell (e.g., NES cell #1 410) at 424.

At 614, the UE 602 may receive cell availability information from the anchor cell 604. In some examples, the cell availability information may include the presence or the absence of a candidate NES cell (e.g., candidate NES cell 606) in each zone of one or more zones. For example, each zone of the one or more zones may correspond to one or more of: a geographic region, a beam coverage area of one or more beams, an RSRP range of a reference signal, or an intersection of multiple RSRP ranges respectively corresponding to multiple cells. For example, referring to FIG. 5, the cell availability information may indicate that BS #1 510 is available for zones 542, 542, 542, 542, 542, and that BS #2 520 is available for zones 550, 552.

In some examples, the UE 602 may determine whether to transmit to the anchor cell 604 the first request for turning on the OD-SSB of a candidate NES cell (e.g., at 620) based on the cell availability information. For example, if the cell availability information indicates the presence of a candidate NES cell at one zone of the one or more zones, the UE 602 may transmit a first request to the anchor cell 604. For example, if the cell availability information indicates the availability of BS #1 510 at the current zone 548 of the UE 502, the UE 502 may transmit a first request to BS #1 510.

In some examples, at 616, the UE 602 may transmit the uplink wakeup signal to the candidate NES cell 606 based on a timing reference. For example, the timing reference may be based on one or more of: a downlink timing reference signal from a reference cell, an uplink wakeup signal timing advance associated with the candidate NES cell (e.g., candidate NES cell 606), or an uplink transmit beam direction and corresponding random access occasion (RO) for the candidate NES cell (e.g., candidate NES cell 606). For example, in FIG. 4, the UE 402 may transmit, via 424, the uplink wakeup signal to the candidate NES cell (e.g., NES cell #1 410).

In some examples, at 620, the UE 602 may transmit a first request for turning on the OD-SSB of a candidate NES cell (e.g., candidate NES cell 606). The first request may include location information of the UE 602, and the UE 602 may be in an RRC idle or inactive state. In some examples, the UE 602 may transmit the first request to the anchor cell 604 (e.g., via a random access channel (RACH) message 618). In some examples, the UE 602 may transmit the first request to the candidate NES cell 606. For example, the UE 602 may transmit the first request to the candidate NES cell 606 based on transmission parameters for an uplink wakeup signal for the candidate NES cell 606 the UE 602 receives at 612. For example, referring to FIG. 4, in some examples, the UE 402 may transmit a first request for turning on the OD-SSB of a candidate NES cell to a candidate NES cell (e.g., NES cell #1 410). In some examples, the UE 402 may transmit a first request (e.g., OD-SSB request 420) for turning on the OD-SSB of a candidate NES cell to an anchor cell 404.

In some examples, at 622, the anchor cell 604 may determine whether there is a candidate NES cell available upon receiving the first request from the UE 602 (e.g., at 620). For example, the anchor cell 604 may determine whether there is a candidate NES cell available based on the location information of the UE 602 in the first request. In some examples, if there is no candidate NES cell available, the anchor cell 604 may, at 624, transmit to the UE 602 a second indication of the absence of the candidate NES cell. Additionally, at 626, the anchor cell 604 may further transmit a third indication for a subsequent request for turning on the OD-SSB. In some examples, the third indication may include a trigger condition for the UE 602 to transmit the subsequent request. For example, the trigger condition may include one or more of: a minimum distance between a current location and a new location of the UE, or a direction associated with the minimum distance.

In some examples, the UE 602 may, at 628, determine whether the trigger condition has been met. At 630, the UE 602 may transmit the subsequent request for turning on the OD-SSB to the anchor cell 604 once the trigger condition has been met. For example, the UE 602 may transmit the subsequent request to the anchor cell 604 once the UE 602 has traveled beyond the minimum distance from its current location in the direction indicated by the third indication.

In some examples, at 632, the UE 602 may communicate with the anchor cell 604 or the candidate NES cell 606 based on the availability of the candidate NES cell 606. For example, if the anchor cell 604 determines that the candidate NES cell 606 is available to UE 602, the anchor cell 604 may activate (e.g., turn on) OD-SSB of the candidate NES cell 606, and the UE 602 may communicate with the candidate NES cell 606. For example, if the anchor cell 604 determines that the candidate NES cell 606 is not available to UE 602, the anchor cell 604 may indicate the absence of the candidate NES cell to the UE 602.

In some examples, after the OD-SSB of the candidate NES cell 606 has been activated (e.g., turned on), the UE 602 may signal the anchor cell 604 to deactivate (e.g., turn off) the OD-SSB of the candidate NES cell 606. For example, at 634, the UE 602 may indicate to the anchor cell 604 a fourth indication for the deactivation of the OD-SSB for the candidate NES cell 606. For example, the UE 602 may transmit the fourth indication to deactivate the OD-SSB of the candidate NES cell 606 if the time duration that the candidate NES cell 606 has been transmitting the SSB has exceeded the maximum time duration, or if the UE 602 moves outside the cell coverage area of the candidate NES cell 606.

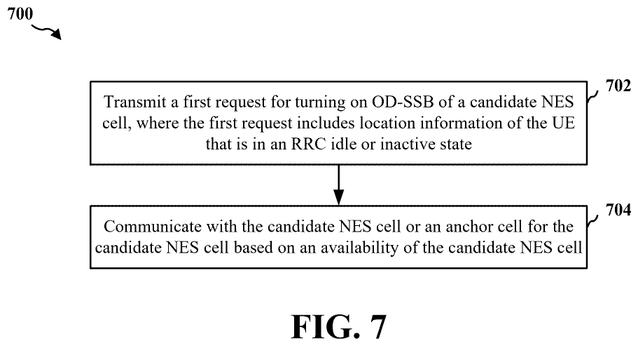

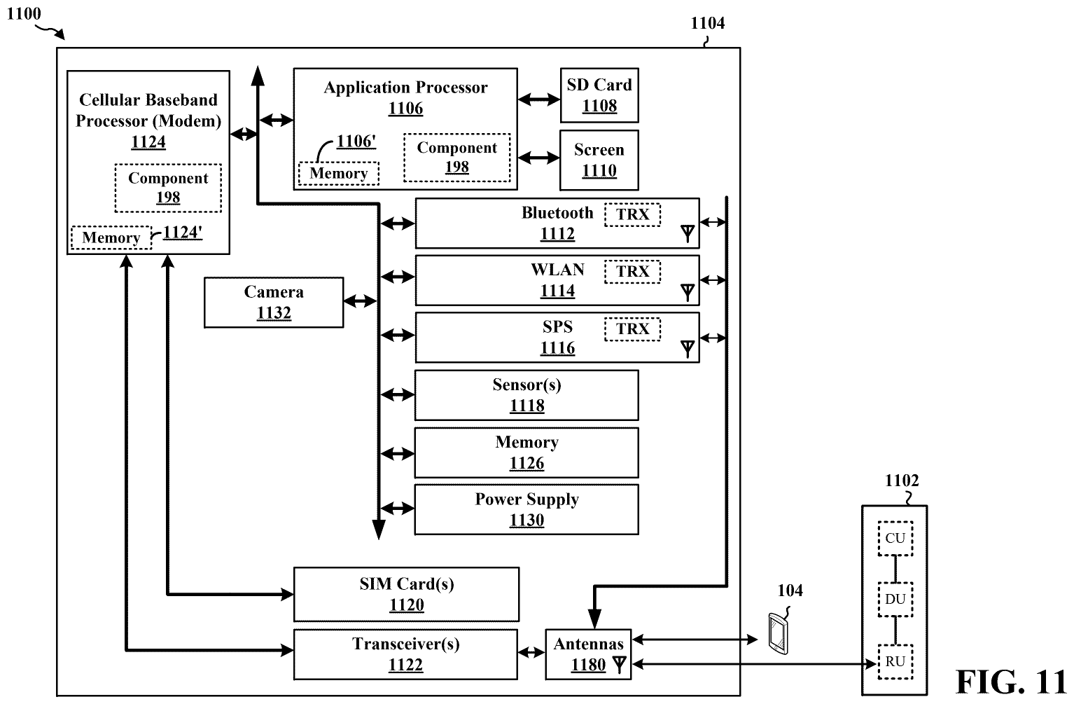

FIG. 7 is a flowchart 700 illustrating methods of wireless communication at a UE in accordance with various aspects of the present disclosure. The method may be performed by a UE in cooperation with a network entity. The network entity may be a base station, or a component of a base station, in the access network of FIG. 1 or a core network component (e.g., base station 102, 310; anchor cell 404, 604; or the network entity 1102 in the hardware implementation of FIG. 11). The UE may be the UE 104, 350, 402, 502, 602, or the apparatus 1104 in the hardware implementation of FIG. 11. By introducing UE-initiated, OD-SSB activation mechanisms based on zone-based NES cell availability information, the methods provide more dynamic and efficient use of network energy and better service availability without compromising user privacy or network security. Additionally, by enabling UEs to send requests for SSB activation when certain thresholds are met, the methods reduce unnecessary transmissions and overall signaling overhead, thereby improving the efficiency of wireless communication. In some aspects, by allowing for the UE to send the OD-SSB requests directly to NES cells based on transmission parameters adjusted for individual zones, the methods reduce the UE's dependency on anchor cells and expedite the SSB activation process, thereby enhancing the responsiveness of the network and minimizing delays in signal availability.

As shown in FIG. 7, at 702, the UE may transmit a first request for turning on the OD-SSB of a candidate NES cell. The first request may include location information of the UE that is in an RRC idle or inactive state. FIG. 4, FIG. 5, and FIG. 6 illustrate various aspects of the steps in connection with flowchart 700. For example, referring to FIG. 6, the UE 602 may, at 620, transmit a first request for turning on the OD-SSB of a candidate NES cell. Referring to FIG. 4, the UE 402 may transmit a first request (e.g., OD-SSB request 420) for turning on the OD-SSB of a candidate NES cell (e.g., NES cell #1 410 or NES cell #2 412). The first request may include location information of the UE 402 that is in an RRC idle or inactive state. In some aspects, 702 may be performed by the OD-SSB component 198.

At 704, the UE may communicate with the candidate NES cell or an anchor cell for the candidate NES cell based on the availability of the candidate NES cell. For example, referring to FIG. 6, the UE 602 may, at 632, communicate with the candidate NES cell 606 or an anchor cell 604 for the candidate NES cell based on the availability of the candidate NES cell. In some aspects, 704 may be performed by the OD-SSB component 198.

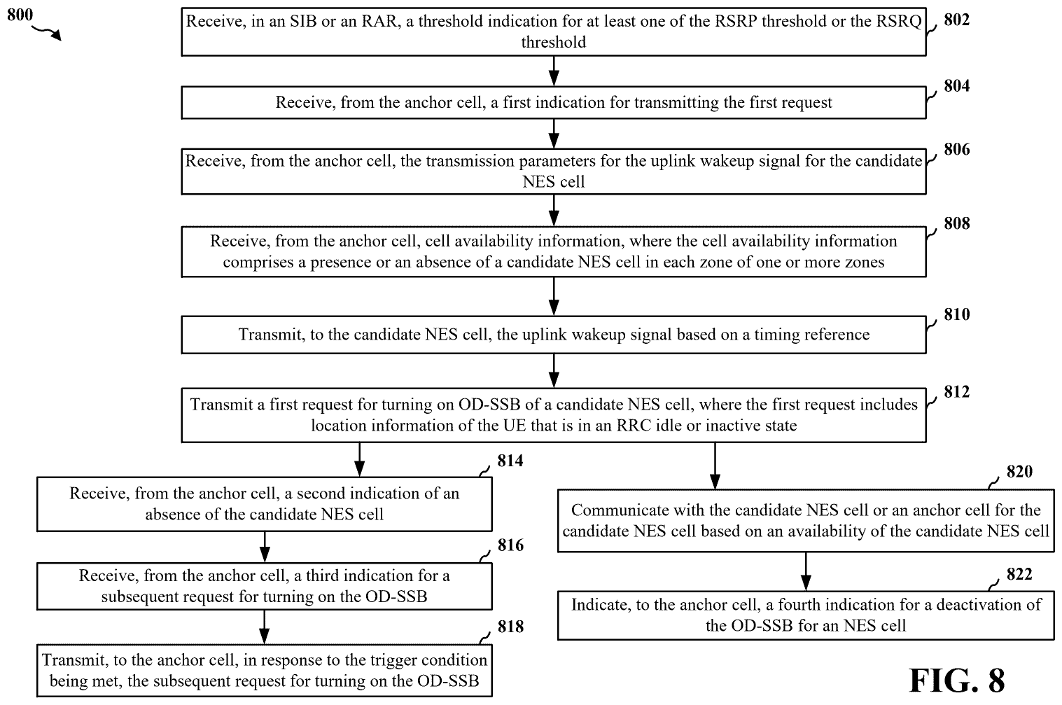

FIG. 8 is a flowchart 800 illustrating methods of wireless communication at a UE in accordance with various aspects of the present disclosure. The method may be performed by a UE in coordination with a network entity. The network entity may be a base station, or a component of a base station, in the access network of FIG. 1 or a core network component (e.g., base station 102, 310, anchor cell 404, 604; or the network entity 1102 in the hardware implementation of FIG. 11). The UE may be the UE 104, 350, 402, 502, 602, or the apparatus 1104 in the hardware implementation of FIG. 11. By introducing UE-initiated, OD-SSB activation mechanisms based on zone-based NES cell availability information, the methods provide more dynamic and efficient use of network energy and better service availability without compromising user privacy or network security. Additionally, by enabling UEs to send requests for SSB activation when certain thresholds are met, the methods reduce unnecessary transmissions and overall signaling overhead, thereby improving the efficiency of wireless communication. In some aspects, by allowing for the UE to send the OD-SSB requests directly to NES cells based on transmission parameters adjusted for individual zones, the methods reduce the UE's dependency on anchor cells and expedite the SSB activation process, thereby enhancing the responsiveness of the network and minimizing delays in signal availability.

As shown in FIG. 8, at 812, the UE may transmit a first request for turning on the OD-SSB of a candidate NES cell. The first request may include location information of the UE that is in an RRC idle or inactive state. FIG. 4, FIG. 5, and FIG. 6 illustrate various aspects of the steps in connection with flowchart 700. For example, referring to FIG. 6, the UE 602 may, at 620, transmit a first request for turning on the OD-SSB of a candidate NES cell. Referring to FIG. 4, the UE 402 may transmit a first request (e.g., OD-SSB request 420) for turning on the OD-SSB of a candidate NES cell (e.g., NES cell #1 410 or NES cell #2 412). The first request may include location information of the UE 402 that is in an RRC idle or inactive state. In some aspects, 812 may be performed by the OD-SSB component 198.

At 820, the UE may communicate with the candidate NES cell or an anchor cell for the candidate NES cell based on the availability of the candidate NES cell. For example, referring to FIG. 6, the UE 602 may, at 632, communicate with the candidate NES cell 606 or an anchor cell 604 for the candidate NES cell based on the availability of the candidate NES cell. In some aspects, 820 may be performed by the OD-SSB component 198.

In some aspects, the UE may transmit the first request for turning on the OD-SSB of the candidate NES cell to the anchor cell via a RACH message. For example, referring to FIG. 6, the UE 602 may, at 620, transmit the first request for turning on the OD-SSB of the candidate NES cell to the anchor cell 604 via a RACH message 618.

In some aspects, at 804, the UE may receive from the anchor cell a first indication for transmitting the first request. In some examples, the first indication may be based on one of: the RSRP of a signal received at the anchor cell being smaller than an RSRP threshold, or the RSRQ of the signal received at the anchor cell being smaller than an RSRQ threshold. In some aspects, the UE may (at 812) transmit the first request for turning on the OD-SSB of the candidate NES cell in response to the first indication. For example, referring to FIG. 6, the UE 602 may, at 610, receive from the anchor cell 604 a first indication for transmitting the first request. In some examples, the anchor cell 604 may send the first indication to the UE 602 if the RSRP of a signal received at the anchor cell 604 is smaller than an RSRP threshold, or the RSRQ of the signal received at the anchor cell 604 is smaller than an RSRQ threshold. In some aspects, 804 may be performed by the OD-SSB component 198.

In some aspects, at 802, the UE may receive, in a SIB or an RAR, a threshold indication for at least one of the RSRP threshold or the RSRQ threshold. For example, referring to FIG. 6, the UE 602 may, at 608, receive a threshold indication for at least one of the RSRP threshold or the RSRQ threshold in a SIB or an RAR. In some aspects, 802 may be performed by the OD-SSB component 198.

In some aspects, the RSRP threshold or the RSRQ threshold may be associated with an SSB of the candidate NES cell. For example, referring to FIG. 6, the RSRP threshold or the RSRQ threshold (e.g., at 608) may be associated with an SSB of the candidate NES cell 606.

In some aspects, the first request may further indicate one or more of: the maximum radius between the UE and the candidate NES cell, the minimum RSRP of a signal received from the candidate NES cell, the minimum RSRQ of the signal received from the candidate NES cell, the maximum transmission power of the UE, or the power state of the UE. For example, referring to FIG. 4, the first request may further indicate one or more of: the maximum radius between the UE 402 and the candidate NES cell (e.g., NES cell #1 410 or NES cell #2 412), the minimum RSRP of a signal received from the candidate NES cell (e.g., NES cell #1 410 or NES cell #2 412), the minimum RSRQ of the signal received from the candidate NES cell (e.g., NES cell #1 410 or NES cell #2 412), the maximum transmission power of the UE 402, or the power state of the UE 402.

In some aspects, at 814, the UE may receive, from the anchor cell, a second indication of an absence of the candidate NES cell, and, at 816, receive, from the anchor cell, a third indication for a subsequent request for turning on the OD-SSB. In some aspects, the third indication may include a trigger condition for the UE to transmit the subsequent request. In some aspects, the trigger condition may include one or more of: the minimum distance between a current location and a new location of the UE, or the direction associated with the minimum distance. For example, referring to FIG. 6, the UE 602 may, at 624, receive from the anchor cell 604 a second indication of an absence of the candidate NES cell. At 626, the UE 602 may receive from the anchor cell 604 a third indication for a subsequent request for turning on the OD-SSB. Referring to FIG. 4, the third indication may include a trigger condition for the UE 402 to transmit the subsequent request. For example, the trigger condition may include one or more of: the minimum distance between a current location and a new location of the UE 402, or the direction associated with the minimum distance. In some aspects, 814 and 816 may be performed by the OD-SSB component 198.

In some aspects, at 818, the UE may transmit, to the anchor cell, the subsequent request for turning on the OD-SSB when the trigger condition has been met. For example, referring to FIG. 6, the UE 602 may, at 630, transmit to the anchor cell 604 the subsequent request for turning on the OD-SSB when the trigger condition has been met. In some aspects, 818 may be performed by the OD-SSB component 198.

In some aspects, at 808, the UE may receive, from the anchor cell, cell availability information. In some aspects, the cell availability information may include a presence or an absence of a candidate NES cell in each zone of one or more zones. In some aspects, each zone of the one or more zones may correspond to one or more of: a geographic region, a beam coverage area of one or more beams, an RSRP range of a reference signal, or an intersection of multiple RSRP ranges respectively corresponding to multiple cells. In some aspects, the UE may (at 812) transmit the first request in response to the presence of the candidate NES cell in one zone of the one or more zones associated with the UE. For example, referring to FIG. 6, the UE 602 may, at 614, receive from the anchor cell 604 cell availability information. Referring to FIG. 5, the cell availability information may include a presence or an absence of a candidate NES cell in each zone of one or more zones (e.g., BS #1 510 is available for zones 542, 544, 546, 548, and BS #2 520 is available for zones 550, 552). For example, each zone of the one or more zones (e.g., zones 542, 544, 546, 548) may correspond to one or more of: a geographic region, a beam coverage area of one or more beams, an RSRP range of a reference signal, or an intersection of multiple RSRP ranges respectively corresponding to multiple cells. For example, the UE 502 may transmit the first request if there is an available candidate NES cell (e.g., BS #1 510) the current zone (e.g., zone 548) of the UE 502. In some aspects, 808 may be performed by the OD-SSB component 198.

In some aspects, the cell availability information may further include one or more zone identifiers (IDs) respectively corresponding to the one or more zones, and the mapping between the one or more zone IDs and NES cell IDs for the candidate NES cells in the one or more zones. In some aspects, the first request (at 812) may include one NES cell ID for the candidate NES cell in the one zone. For example, referring to FIG. 5, the cell availability information may further include zone IDs respectively corresponding to the one or more zones (e.g., zones 542, 544, 546, 548), and the mapping between the one or more zone IDs and NES cell IDs for the candidate NES cells in the one or more zones (e.g., the mapping of zone ID for zone 542 to BS #1 510).

In some aspects, the UE may (at 812) transmit the first request to the candidate NES cell based on transmission parameters for an uplink wakeup signal for the candidate NES cell. For example, referring to FIG. 6, the UE 602 may (at 620) transmit the first request to the candidate NES cell 606 based on transmission parameters for an uplink wakeup signal for the candidate NES cell (received at 612).

In some aspects, at 806, the UE may receive the transmission parameters for the uplink wakeup signal for the candidate NES cell from the anchor cell. In some aspects, the transmission parameters for the uplink wakeup signal may include one or more of: TA for the uplink wakeup signal, a UE transmit beam direction for the uplink wakeup signal, an RO or beam for receiving the uplink wakeup signal. For example, referring to FIG. 6, the UE 602 may, at 612, receive the transmission parameters for the uplink wakeup signal for the candidate NES cell from the anchor cell 604. In some examples, the transmission parameters for the uplink wakeup signal may include one or more of: TA for the uplink wakeup signal, a UE transmit beam direction for the uplink wakeup signal, an RO or beam for receiving the uplink wakeup signal. In some aspects, 806 may be performed by the OD-SSB component 198.

In some aspects, the TA for the uplink wakeup signal may be based on one or more of: downlink or uplink timing of a reference cell, a UTC time, or a GPS time. For example, referring to FIG. 6, the TA for the uplink wakeup signal (which is included in the transmission parameters at 612) may be based on one or more of: downlink or uplink timing of a reference cell, a UTC time, or a GPS time.

In some aspects, at 810, the UE may transmit, to the candidate NES cell, the uplink wakeup signal based on a timing reference. In some aspects, the timing reference may be based on one or more of: a downlink timing reference signal from a reference cell, an uplink wakeup signal timing advance associated with the candidate NES cell, or an uplink transmit beam direction and corresponding RO for the candidate NES cell. For example, referring to FIG. 6, the UE 602 may, at 616, transmit to the candidate NES cell 606 the uplink wakeup signal based on a timing reference. In some aspects, 810 may be performed by the OD-SSB component 198.

In some aspects, at 822, the UE may indicate, to the anchor cell, a fourth indication for a deactivation of the OD-SSB for an NES cell. For example, referring to FIG. 6, the UE 602 may, at 634, indicate to the anchor cell 604 a fourth indication for a deactivation of the OD-SSB for an NES cell. In some aspects, 822 may be performed by the OD-SSB component 198.

In some aspects, the deactivation of the OD-SSB of the NES cell (at 822) may be based on one or more of: the time duration the NES cell has been transmitting synchronization signal blocks (SSB) has exceeded the maximum time duration, or the UE is outside a cell coverage area of the NES cell. For example, referring to FIG. 6, the UE 602 may transmit the fourth indication to deactivate the OD-SSB of the candidate NES cell 606 if the time duration that the candidate NES cell 606 has been transmitting the SSB has exceeded the maximum time duration, or if the UE 602 moves outside the cell coverage area of the candidate NES cell 606.

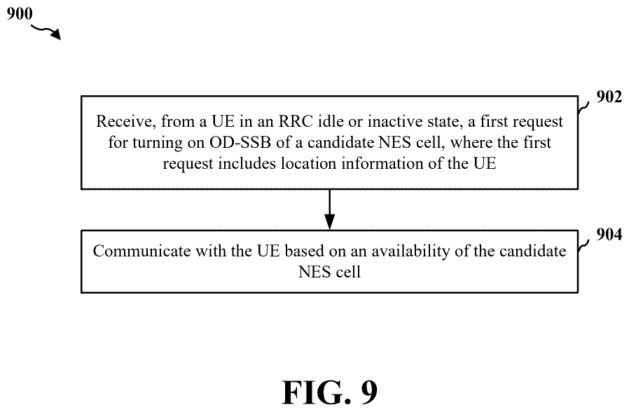

FIG. 9 is a flowchart 900 illustrating methods of wireless communication at a network entity in accordance with various aspects of the present disclosure. The method may be performed by a network entity in cooperation with a UE. The network entity may be a base station, or a component of a base station, in the access network of FIG. 1 or a core network component (e.g., base station 102, 310, anchor cell 404, 604; or the network entity 1102 in the hardware implementation of FIG. 11). The UE may be the UE 104, 350, 402, 502, 602, or the apparatus 1104 in the hardware implementation of FIG. 11. By introducing UE-initiated, OD-SSB activation mechanisms based on zone-based NES cell availability information, the methods provide more dynamic and efficient use of network energy and better service availability without compromising user privacy or network security. Additionally, by enabling UEs to send requests for SSB activation when certain thresholds are met, the methods reduce unnecessary transmissions and overall signaling overhead, thereby improving the efficiency of wireless communication. In some aspects, by allowing for the UE to send the OD-SSB requests directly to NES cells based on transmission parameters adjusted for individual zones, the methods reduce the UE's dependency on anchor cells and expedite the SSB activation process, thereby enhancing the responsiveness of the network and minimizing delays in signal availability.

As shown in FIG. 9, at 902, the network entity may receive, from a UE in an RRC idle or inactive state, a first request for turning on the OD-SSB of a candidate NES cell. The first request may include location information of the UE. FIG. 4, FIG. 5, and FIG. 6 illustrate various aspects of the steps in connection with flowchart 900. For example, referring to FIG. 6, the network entity (e.g., anchor cell 604) may, at 620, receive from a UE 602 in an RRC idle or inactive state a first request for turning on the OD-SSB of a candidate NES cell 606. The first request may include location information of the UE. In some aspects, 902 may be performed by the OD-SSB component 199.

At 904, the network entity may communicate with the UE based on the availability of the candidate NES cell. For example, referring to FIG. 6, the network entity (e.g., anchor cell 604) may, at 632, communicate with the UE 602 based on the availability of the candidate NES cell 606. In some aspects, 904 may be performed by the OD-SSB component 199.

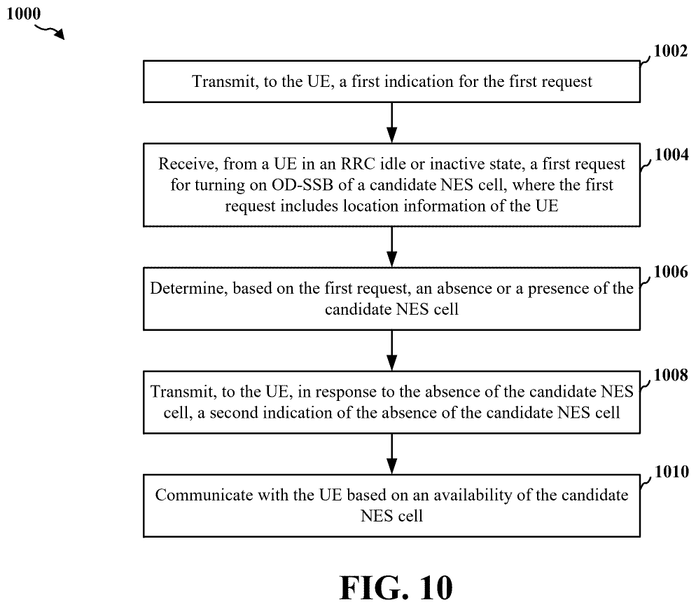

FIG. 10 is a flowchart 1000 illustrating methods of wireless communication at a network entity in accordance with various aspects of the present disclosure. The method may be performed by a network entity in coordination with a UE. The network entity may be a base station, or a component of a base station, in the access network of FIG. 1 or a core network component (e.g., base station 102, 310, anchor cell 404, 604; or the network entity 1102 in the hardware implementation of FIG. 11). The UE may be the UE 104, 350, 402, 502, 602, or the apparatus 1104 in the hardware implementation of FIG. 11. By introducing UE-initiated, OD-SSB activation mechanisms based on zone-based NES cell availability information, the methods provide more dynamic and efficient use of network energy and better service availability without compromising user privacy or network security. Additionally, by enabling UEs to send requests for SSB activation when certain thresholds are met, the methods reduce unnecessary transmissions and overall signaling overhead, thereby improving the efficiency of wireless communication. In some aspects, by allowing for the UE to send the OD-SSB requests directly to NES cells based on transmission parameters adjusted for individual zones, the methods reduce the UE's dependency on anchor cells and expedite the SSB activation process, thereby enhancing the responsiveness of the network and minimizing delays in signal availability.

As shown in FIG. 10, at 1004, the network entity may receive, from a UE in an RRC idle or inactive state, a first request for turning on the OD-SSB of a candidate NES cell. The first request may include location information of the UE. FIG. 4, FIG. 5, and FIG. 6 illustrate various aspects of the steps in connection with flowchart 1000. For example, referring to FIG. 6, the network entity (e.g., anchor cell 604) may, at 620, receive from a UE 602 in an RRC idle or inactive state a first request for turning on the OD-SSB of a candidate NES cell 606. The first request may include location information of the UE. In some aspects, 1004 may be performed by the OD-SSB component 199.

At 1010, the network entity may communicate with the UE based on the availability of the candidate NES cell. For example, referring to FIG. 6, the network entity (e.g., anchor cell 604) may, at 632, communicate with the UE 602 based on the availability of the candidate NES cell 606. In some aspects, 1010 may be performed by the OD-SSB component 199.

In some aspects, at 1002, the network entity may transmit, to the UE, a first indication for the first request. In some aspects, the first indication may be based on one of: the RSRP of a signal received at the network entity is smaller than an RSRP threshold, or the RSRQ of the signal received at the network entity is smaller than an RSRQ threshold. For example, referring to FIG. 6, the network entity (e.g., anchor cell 604) may, at 610, transmit to the UE 602 a first indication for the first request. Referring to FIG. 4, the first indication may be based on one of: the RSRP of a signal received at the network entity (e.g., anchor cell 404) is smaller than an RSRP threshold, or the RSRQ of the signal received at the network entity (e.g., anchor cell 404) is smaller than an RSRQ threshold. In some aspects, 1002 may be performed by the OD-SSB component 199.

In some aspects, the network entity may, at 1006, determine, based on the first request, an absence or a presence of the candidate NES cell, and, at 1008, transmit, to the UE, in response to the absence of the candidate NES cell, a second indication of the absence of the candidate NES cell. For example, referring to FIG. 6, the network entity (e.g., anchor cell 604) may, at 622, determine, based on the first request, an absence or a presence of the candidate NES cell. At 624, the network entity (e.g., anchor cell 604) may transmit to the UE 602, in response to the absence of the candidate NES cell, a second indication of the absence of the candidate NES cell. In some aspects, 1006 and 1008 may be performed by the OD-SSB component 199.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor (or processing circuitry) 1124 (also referred to as a modem) coupled to one or more transceivers 1122 (e.g., cellular RF transceiver). The cellular baseband processor(s) (or processing circuitry) 1124 may include at least one on-chip memory (or memory circuitry) 1124′. In some aspects, the apparatus 1104 may further include one or more subscriber identity modules (SIM) cards 1120 and at least one application processor (or processing circuitry) 1106 coupled to a secure digital (SD) card 1108 and a screen 1110. The application processor(s) (or processing circuitry) 1106 may include on-chip memory (or memory circuitry) 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) (or processing circuitry) 1124 communicates through the transceiver(s) 1122 via one or more antennas 1180 with the UE 104 and/or with an RU associated with a network entity 1102. The cellular baseband processor(s) (or processing circuitry) 1124 and the application processor(s) (or processing circuitry) 1106 may each include a computer-readable medium/memory (or memory circuitry) 1124′, 1106′, respectively. The additional memory modules 1126 may also be considered a computer-readable medium/memory (or memory circuitry). Each computer-readable medium/memory (or memory circuitry) 1124′, 1106′, 1126 may be non-transitory. The cellular baseband processor(s) (or processing circuitry) 1124 and the application processor(s) (or processing circuitry) 1106 are each responsible for general processing, including the execution of software stored on the computer-readable medium/memory (or memory circuitry). The software, when executed by the cellular baseband processor(s) (or processing circuitry) 1124/application processor(s) (or processing circuitry) 1106, causes the cellular baseband processor(s) (or processing circuitry) 1124/application processor(s) (or processing circuitry) 1106 to perform the various functions described supra. The cellular baseband processor(s) (or processing circuitry) 1124 and the application processor(s) (or processing circuitry) 1106 are configured to perform the various functions described supra based at least in part of the information stored in the memory (or memory circuitry). That is, the cellular baseband processor(s) (or processing circuitry) 1124 and the application processor(s) (or processing circuitry) 1106 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1124/application processor(s) (or processing circuitry) 1106 when executing software. The cellular baseband processor(s) (or processing circuitry) 1124/application processor(s) (or processing circuitry) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) (or processing circuitry) 1124 and/or the application processor(s) (or processing circuitry) 1106, and in another configuration, the apparatus 1104 may be the entire UE (e.g., see UE 350 of FIG. 3) and include the additional modules of the apparatus 1104.

As discussed supra, the component 198 may be configured to transmit a first request for turning on the OD-SSB of a candidate NES cell, where the first request includes location information of the UE that is in an RRC idle or inactive state; and communicate with the candidate NES cell or an anchor cell for the candidate NES cell based on the availability of the candidate NES cell. The component 198 may be further configured to perform any of the aspects described in connection with the flowcharts in FIG. 7 and FIG. 8, and/or performed by the UE 602 in FIG. 6. The component 198 may be within the cellular baseband processor(s) (or processing circuitry) 1124, the application processor(s) (or processing circuitry) 1106, or both the cellular baseband processor(s) (or processing circuitry) 1124 and the application processor(s) (or processing circuitry) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) (or processing circuitry) 1124 and/or the application processor(s) (or processing circuitry) 1106, includes means for transmitting a first request for turning on the OD-SSB of a candidate NES cell, where the first request includes location information of the UE that is in an RRC idle or inactive state, and means for communicating with the candidate NES cell or an anchor cell for the candidate NES cell based on the availability of the candidate NES cell. The apparatus 1104 may further include means for performing any of the aspects described in connection with the flowcharts in FIG. 7 and FIG. 8, and/or aspects performed by the UE 602 in FIG. 6. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

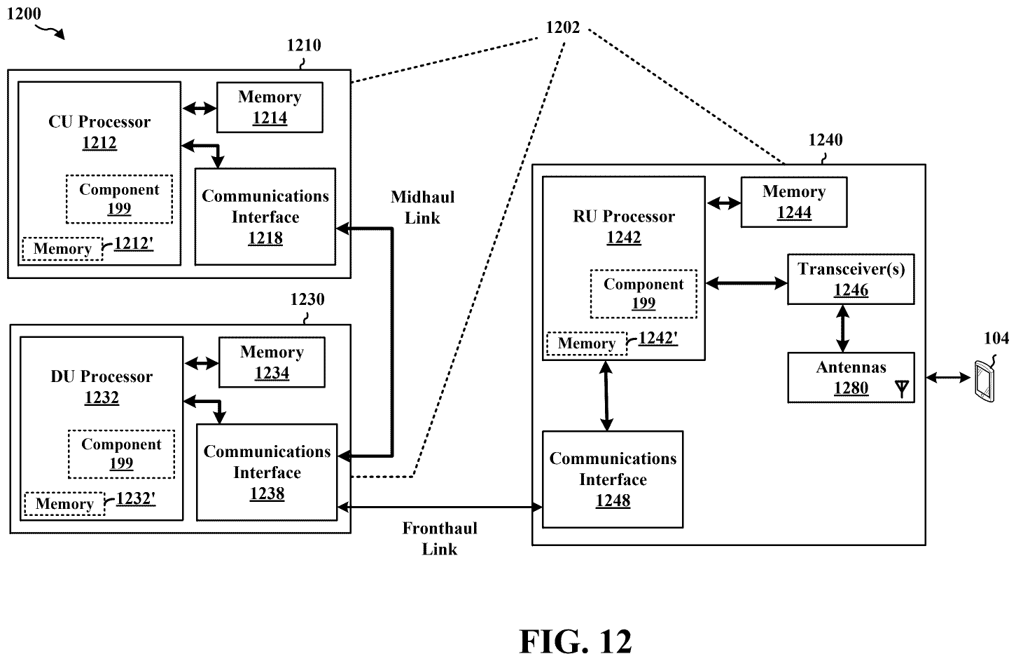

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor (or processing circuitry) 1212. The CU processor(s) (or processing circuitry) 1212 may include on-chip memory (or memory circuitry) 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor (or processing circuitry) 1232. The DU processor(s) (or processing circuitry) 1232 may include on-chip memory (or memory circuitry) 1232′. In some aspects, the DU 1230 may further include additional memory modules 1234 and a communications interface 1238. The DU 1230 communicates with the RU 1240 through a fronthaul link. The RU 1240 may include at least one RU processor (or processing circuitry) 1242. The RU processor(s) (or processing circuitry) 1242 may include on-chip memory (or memory circuitry) 1242′. In some aspects, the RU 1240 may further include additional memory modules 1244, one or more transceivers 1246, antennas 1280, and a communications interface 1248. The RU 1240 communicates with the UE 104. The on-chip memory (or memory circuitry) 1212′, 1232′, 1242′ and the additional memory modules 1214, 1234, 1244 may each be considered a computer-readable medium/memory (or memory circuitry). Each computer-readable medium/memory (or memory circuitry) may be non-transitory. Each of the processors (or processing circuitry) 1212, 1232, 1242 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to receive, from a UE in an RRC idle or inactive state, a first request for turning on the OD-SSB of a candidate NES cell, where the first request includes location information of the UE; and communicate with the UE based on the availability of the candidate NES cell. The component 199 may be further configured to perform any of the aspects described in connection with the flowcharts in FIG. 9 and FIG. 10, and/or performed by the anchor cell 604 in FIG. 6. The component 199 may be within one or more processors (or processing circuitry) of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 includes means for receiving, from a UE in an RRC idle or inactive state, a first request for turning on the OD-SSB of a candidate NES cell, where the first request includes location information of the UE, and means for communicating with the UE based on the availability of the candidate NES cell. The network entity 1202 may further include means for performing any of the aspects described in connection with the flowcharts in FIG. 9 and FIG. 10, and/or aspects performed by the anchor cell 604 in FIG. 6. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include transmitting a first request for turning on the OD-SSB of a candidate NES cell, where the first request includes location information of the UE that is in an RRC idle or inactive state; and communicating with the candidate NES cell or an anchor cell for the candidate NES cell based on the availability of the candidate NES cell. By introducing UE-initiated, OD-SSB activation mechanisms based on zone-based NES cell availability information, the methods provide more dynamic and efficient use of network energy and better service availability without compromising user privacy or network security. Additionally, by enabling UEs to send requests for SSB activation when certain thresholds are met, the methods reduce unnecessary transmissions and overall signaling overhead, thereby improving the efficiency of wireless communication. In some aspects, by allowing for the UE to send the OD-SSB requests directly to NES cells based on transmission parameters adjusted for individual zones, the methods reduce the UE's dependency on anchor cells and expedite the SSB activation process, thereby enhancing the responsiveness of the network and minimizing delays in signal availability.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes transmitting a first request for turning on on-demand synchronization signal block (OD-SSB) of a candidate network energy saving (NES) cell, wherein the first request comprises location information of the UE that is in a radio resource control (RRC) idle or inactive state; and communicating with the candidate NES cell or an anchor cell for the candidate NES cell based on an availability of the candidate NES cell.

Aspect 2 is the method of aspect 1, wherein transmitting the first request for turning on the OD-SSB of the candidate NES cell includes transmitting, to the anchor cell, via a random access channel (RACH) message, the first request for turning on the OD-SSB of the candidate NES cell.

Aspect 3 is the method of any of aspects 1 to 2, where the method further includes receiving, from the anchor cell, a first indication for transmitting the first request, wherein the first indication is based on one of: a reference signal received power (RSRP) of a signal received at the anchor cell being smaller than an RSRP threshold, or a reference signal received quality (RSRQ) of the signal received at the anchor cell being smaller than an RSRQ threshold, and wherein transmitting the first request for turning on the OD-SSB of the candidate NES cell includes transmitting, in response to the first indication, the first request for turning on the OD-SSB of the candidate NES cell.

Aspect 4 is the method of aspect 3, where the method further includes receiving, in a system information block (SIB) or a random access response (RAR), a threshold indication for at least one of the RSRP threshold or the RSRQ threshold.

Aspect 5 is the method of aspect 3, wherein the RSRP threshold or the RSRQ threshold is associated with a synchronization signal block (SSB) of the candidate NES cell.

Aspect 6 is the method of any of aspects 1 to 2, wherein the first request further indicates one or more of: a maximum radius between the UE and the candidate NES cell, a minimum reference signal received power (RSRP) of a signal received from the candidate NES cell, a minimum reference signal received quality (RSRQ) of the signal received from the candidate NES cell, a maximum transmission power of the UE, or a power state of the UE.

Aspect 7 is the method of any of aspects 1 to 2, where the method further includes receiving, from the anchor cell, a second indication of an absence of the candidate NES cell; and receiving, from the anchor cell, a third indication for a subsequent request for turning on the OD-SSB, wherein the third indication includes a trigger condition for the UE to transmit the subsequent request, wherein the trigger condition includes one or more of: a minimum distance between a current location and a new location of the UE, or a direction associated with the minimum distance.

Aspect 8 is the method of aspect 7, where the method further includes transmitting, to the anchor cell, in response to the trigger condition being met, the subsequent request for turning on the OD-SSB.

Aspect 9 is the method of any of aspects 1 to 8, where the method further includes receiving, from the anchor cell, cell availability information, wherein the cell availability information comprises a presence or an absence of a candidate NES cell in each zone of one or more zones, wherein each zone of the one or more zones corresponds to one or more of: a geographic region, a beam coverage area of one or more beams, an RSRP range of a reference signal, or an intersection of multiple RSRP ranges respectively corresponding to multiple cells, and wherein transmitting the first request includes transmitting the first request in response to the presence of the candidate NES cell in one zone of the one or more zones associated with the UE.

Aspect 10 is the method of aspect 9, wherein the cell availability information further comprises one or more zone identifiers (IDs) respectively corresponding to the one or more zones, and a mapping between the one or more zone IDs and NES cell IDs for the candidate NES cells in the one or more zones, and wherein the first request comprises one NES cell ID for the candidate NES cell in the one zone.

Aspect 11 is the method of aspect 9, wherein transmitting the first request includes transmitting, to the candidate NES cell, the first request based on transmission parameters for an uplink wakeup signal for the candidate NES cell.

Aspect 12 is the method of aspect 11, where the method further includes receiving, from the anchor cell, the transmission parameters for the uplink wakeup signal for the candidate NES cell, wherein the transmission parameters for the uplink wakeup signal include one or more of: timing advance (TA) for the uplink wakeup signal, a UE transmit beam direction for the uplink wakeup signal, a random access channel (RACH) occasion (RO) or beam for receiving the uplink wakeup signal.

Aspect 13 is the method of aspect 12, wherein the TA for the uplink wakeup signal is based on one or more of: downlink or uplink timing of a reference cell, a coordinated universal time (UTC) time, or a global positioning system (GPS) time.

Aspect 14 is the method of aspect 11, where the method further includes transmitting, to the candidate NES cell, the uplink wakeup signal based on a timing reference, wherein the timing reference is based on one or more of: a downlink timing reference signal from a reference cell, an uplink wakeup signal timing advance associated with the candidate NES cell, or an uplink transmit beam direction and corresponding random access occasion (RO) for the candidate NES cell.

Aspect 15 is the method of aspect 9, where the method further includes indicating, to the anchor cell, a fourth indication for a deactivation of the OD-SSB for an NES cell.

Aspect 16 is the method of aspect 15, wherein the deactivation of the OD-SSB of the NES cell is based on one or more of: a time duration the NES cell has been transmitting synchronization signal blocks (SSB) exceeding a maximum time duration, or the UE being outside a cell coverage area of the NES cell.

Aspect 17 is an apparatus for wireless communication at a UE, comprising: a processing system that includes processor circuitry and memory circuitry that stores code and is coupled with the processor circuitry, the processing system configured to cause the UE to perform the method of one or more of aspects 1-16.

Aspect 18 is an apparatus for wireless communication at a UE, comprising: at least one memory; and at least one processor coupled to the at least one memory and, where the at least one processor, individually or in any combination, is configured to perform the method of any of aspects 1-16.

Aspect 19 is the apparatus for wireless communication at a UE, comprising means for performing each step in the method of any of aspects 1-16.

Aspect 20 is an apparatus of any of aspects 17-19, further comprising a transceiver configured to receive or to transmit in association with the method of any of aspects 1-16.

Aspect 21 is a computer-readable medium (e.g., a non-transitory computer-readable medium) storing computer executable code at a UE, the code when executed by at least one processor causes the at least one processor to, individually or in any combination, perform the method of any of aspects 1-16.

Aspect 22 is a method of wireless communication at a network entity. The method includes receiving, from a user equipment (UE) in a radio resource control (RRC) idle or inactive state, a first request for turning on on-demand synchronization signal block (OD-SSB) of a candidate network energy saving (NES) cell, wherein the first request comprises location information of the UE; and communicating with the UE based on an availability of the candidate NES cell.

Aspect 23 is the method of aspect 22, where the method further includes transmitting, to the UE, a first indication for the first request, wherein the first indication is based on one of: a reference signal received power (RSRP) of a signal received at the network entity being smaller than an RSRP threshold, or a reference signal received quality (RSRQ) of the signal received at the network entity being smaller than an RSRQ threshold.

Aspect 24 is the method of any of aspects 22 to 23, where the method further includes determining, based on the first request, an absence or a presence of the candidate NES cell; and transmitting, to the UE, in response to the absence of the candidate NES cell, a second indication of the absence of the candidate NES cell.

Aspect 25 is an apparatus for wireless communication at a network entity, comprising: a processing system that includes processor circuitry and memory circuitry that stores code and is coupled with the processor circuitry, the processing system configured to cause the network entity to perform the method of one or more of aspects 22-24.

Aspect 26 is an apparatus for wireless communication at a network entity, comprising: at least one memory; and at least one processor coupled to the at least one memory and, where the at least one processor, individually or in any combination, is configured to perform the method of any of aspects 22-24.

Aspect 27 is the apparatus for wireless communication at a network entity, comprising means for performing each step in the method of any of aspects 22-24.

Aspect 28 is an apparatus of any of aspects 25-27, further comprising a transceiver configured to receive or to transmit in association with the method of any of aspects 22-24.

Aspect 29 is a computer-readable medium (e.g., a non-transitory computer-readable medium) storing computer executable code at a network entity, the code when executed by at least one processor causes the at least one processor to, individually or in any combination, perform the method of any of aspects 22-24.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
transmit a first request for turning on on-demand synchronization signal block (OD-SSB) of a candidate network energy saving (NES) cell, wherein the first request comprises location information of the UE that is in a radio resource control (RRC) idle or inactive state; and
communicate with the candidate NES cell or an anchor cell for the candidate NES cell based on an availability of the candidate NES cell.

2. The apparatus of claim 1, further comprising a transceiver coupled to the at least one processor, wherein to transmit the first request for turning on the OD-SSB of the candidate NES cell, the at least one processor, individually or in any combination, is configured to cause the UE to transmit the first request for turning on the OD-SSB of the candidate NES cell via the transceiver, and wherein to transmit the first request for turning on the OD-SSB of the candidate NES cell, the at least one processor, individually or in any combination, is configured to cause the UE to:
transmit, to the anchor cell, via a random access channel (RACH) message, the first request for turning on the OD-SSB of the candidate NES cell.

3. The apparatus of claim 2, wherein the at least one processor, individually or in any combination, is further configured to cause the UE to:
receive, from the anchor cell, a first indication for transmitting the first request, wherein the first indication is based on one of:
a reference signal received power (RSRP) of a signal received at the anchor cell being smaller than an RSRP threshold, or
a reference signal received quality (RSRQ) of the signal received at the anchor cell being smaller than an RSRQ threshold, and
wherein to transmit the first request for turning on the OD-SSB of the candidate NES cell, the at least one processor, individually or in any combination, is configured to cause the UE to:
transmit, in response to the first indication, the first request for turning on the OD-SSB of the candidate NES cell.

4. The apparatus of claim 3, wherein the at least one processor, individually or in any combination, is configured to cause the UE to:
receive, in a system information block (SIB) or a random access response (RAR), a threshold indication for at least one of the RSRP threshold or the RSRQ threshold.

5. The apparatus of claim 3, wherein the RSRP threshold or the RSRQ threshold is associated with a synchronization signal block (SSB) of the candidate NES cell.

6. The apparatus of claim 2, wherein the first request further indicates one or more of:
a maximum radius between the UE and the candidate NES cell,
a minimum reference signal received power (RSRP) of a signal received from the candidate NES cell,
a minimum reference signal received quality (RSRQ) of the signal received from the candidate NES cell,
a maximum transmission power of the UE, or
a power state of the UE.

7. The apparatus of claim 2, wherein the at least one processor, individually or in any combination, is configured to cause the UE to:
receive, from the anchor cell, a second indication of an absence of the candidate NES cell; and
receive, from the anchor cell, a third indication for a subsequent request for turning on the OD-SSB, wherein the third indication includes a trigger condition for the UE to transmit the subsequent request, wherein the trigger condition includes one or more of:
a minimum distance between a current location and a new location of the UE, or
a direction associated with the minimum distance.

8. The apparatus of claim 7, wherein the at least one processor, individually or in any combination, is configured to cause the UE to:
transmit, to the anchor cell, in response to the trigger condition being met, the subsequent request for turning on the OD-SSB.

9. The apparatus of claim 1, wherein the at least one processor, individually or in any combination, is configured to cause the UE to:
receive, from the anchor cell, cell availability information, wherein the cell availability information comprises a presence or an absence of a candidate NES cell in each zone of one or more zones, wherein each zone of the one or more zones corresponds to one or more of:
a geographic region,
a beam coverage area of one or more beams,
an RSRP range of a reference signal, or
an intersection of multiple RSRP ranges respectively corresponding to multiple cells,
and wherein to transmit the first request, the at least one processor, individually or in any combination, is configured to cause the UE to:
transmit the first request in response to the presence of the candidate NES cell in one zone of the one or more zones associated with the UE.

10. The apparatus of claim 9, wherein the cell availability information further comprises one or more zone identifiers (IDs) respectively corresponding to the one or more zones, and a mapping between the one or more zone IDs and NES cell IDs for the candidate NES cells in the one or more zones, and wherein the first request comprises one NES cell ID for the candidate NES cell in the one zone.

11. The apparatus of claim 9, wherein to transmit the first request, the at least one processor, individually or in any combination, is configured to cause the UE to:
transmit, to the candidate NES cell, the first request based on transmission parameters for an uplink wakeup signal for the candidate NES cell.

12. The apparatus of claim 11, wherein the at least one processor, individually or in any combination, is configured to cause the UE to:
receive, from the anchor cell, the transmission parameters for the uplink wakeup signal for the candidate NES cell, wherein the transmission parameters for the uplink wakeup signal include one or more of:
timing advance (TA) for the uplink wakeup signal,
a UE transmit beam direction for the uplink wakeup signal,
a random access channel (RACH) occasion (RO) or beam for receiving the uplink wakeup signal.

13. The apparatus of claim 12, wherein the TA for the uplink wakeup signal is based on one or more of:
downlink or uplink timing of a reference cell,
a coordinated universal time (UTC) time, or
a global positioning system (GPS) time.

14. The apparatus of claim 11, wherein the at least one processor, individually or in any combination, is configured to cause the UE to:
transmit, to the candidate NES cell, the uplink wakeup signal based on a timing reference, wherein the timing reference is based on one or more of:
a downlink timing reference signal from a reference cell,
an uplink wakeup signal timing advance associated with the candidate NES cell, or
an uplink transmit beam direction and corresponding random access occasion (RO) for the candidate NES cell.

15. The apparatus of claim 9, wherein the at least one processor, individually or in any combination, is configured to cause the UE to:
indicate, to the anchor cell, a fourth indication for a deactivation of the OD-SSB for an NES cell.

16. The apparatus of claim 15, wherein the deactivation of the OD-SSB of the NES cell is based on one or more of:
a time duration the NES cell has been transmitting synchronization signal blocks (SSB) exceeding a maximum time duration, or
the UE being outside a cell coverage area of the NES cell.

17. An apparatus for wireless communication at a network entity, comprising:
at least one memory; and
at least one processor coupled to the at least one memory and, based at least in part on information stored in the at least one memory, the at least one processor, individually or in any combination, is configured to cause the network entity to:
receive, from a user equipment (UE) in a radio resource control (RRC) idle or inactive state, a first request for turning on on-demand synchronization signal block (OD-SSB) of a candidate network energy saving (NES) cell, wherein the first request comprises location information of the UE; and
communicate with the UE based on an availability of the candidate NES cell.

18. The apparatus of claim 17, further comprising a transceiver coupled to the at least one processor, wherein to receive the first request for turning on the OD-SSB of the candidate NES cell, the at least one processor, individually or in any combination, is configured to cause the network entity to receive the first request for turning on the OD-SSB of the candidate NES cell via the transceiver, and wherein the at least one processor, individually or in any combination, is configured to cause the network entity to:
transmit, to the UE, a first indication for the first request, wherein the first indication is based on one of:
a reference signal received power (RSRP) of a signal received at the network entity being smaller than an RSRP threshold, or
a reference signal received quality (RSRQ) of the signal received at the network entity being smaller than an RSRQ threshold.

19. The apparatus of claim 17, wherein the at least one processor, individually or in any combination, is configured to cause the network entity to:
determine, based on the first request, an absence or a presence of the candidate NES cell; and
transmit, to the UE, in response to the absence of the candidate NES cell, a second indication of the absence of the candidate NES cell.

20. A method of wireless communication at a user equipment (UE), comprising:
transmitting a first request for turning on on-demand synchronization signal block (OD-SSB) of a candidate network energy saving (NES) cell, wherein the first request comprises location information of the UE that is in a radio resource control (RRC) idle or inactive state; and
communicating with the candidate NES cell or an anchor cell for the candidate NES cell based on an availability of the candidate NES cell.
